(19) United States
(12) Patent Application Publication
(10) Pub. No.: US 2025/0037163 A1
(43) Pub. Date: Jan. 30, 2025

(54) AUTOMATED BRAND AUTHENTICATION IN METAVERSE

(71) Applicant: INTERNATIONAL BUSINESS MACHINES CORPORATION, Armonk, NY (US)

(72) Inventors: Jignesh Karia, Thane (IN); Mukundan Sundararajan, Bangalore (IN); NEHA SHAH, Kolkata (IN); Pankaj Satyanarayan Dayama, Bangalore (IN); SHILPA SHETTY, Sydney (AU)

(21) Appl. No.: 18/227,070

(22) Filed: Jul. 27, 2023

(51) Int. Cl. G06Q 30/0251; G06Q 30/0241

(52) U.S. Cl. CPC G06Q 30/0258; G06Q 30/0248; G06Q 30/0277

(57) ABSTRACT

A system, method, and computer program product are configured to receive a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product; receive a hash pre-image; compare the hash pre-image with the first hash; retrieve a list of users associated with the virtual IDs of the first hash; generate tokens, respective ones of the tokens associated with respective ones of the users; and transmit the tokens to a server associated with the branded product.

### BACKGROUND

Aspects of the present invention relate generally to message authentication and, more particularly, to methods and systems for automatically authenticating messages based on interactions in the metaverse, particularly when brands send messages, e.g., via a telemarketer, to real world users of the metaverse.

A metaverse is a virtual immersive environment (virtual world) which spans the virtual and physical world. In a metaverse, an individual can select a persona (also known as an avatar) which represents the individual in the metaverse. This avatar provides a transition of individual from real world to metaverse. The presence of the individual in the metaverse is mapped in the metaverse through his/her avatar which interacts with the entities of the virtual world from shopping, to travelling, to attending events. Entities, such as owners of branded products, which participate in the metaverse events may provide their own products which are available to the avatars as products or features. Along with the metaverse events, the products presented in the metaverse can translate to real world products for purchase by the individual in the real world.

### SUMMARY

In a first aspect of the invention, there is a computer-implemented method including: receiving, by a processor set, a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product; receiving, by the processor set, a hash pre-image; comparing, by the processor set, the hash pre-image with the first hash to authenticate the branded product; retrieving, by the processor set, a list of users associated with the virtual IDs of the first hash; generating, by the processor set, tokens, respective ones of the tokens being associated with respective ones of the users; and transmitting, by the processor set, the tokens to a server associated with the branded product.

In another aspect of the invention, there is a computer program product including one or more computer readable storage media having program instructions collectively stored on the one or more computer readable storage media. The program instructions are executable to: receive a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product; receive a hash pre-image; compare the hash pre-image with the first hash; retrieve a list of users associated with the virtual IDs of the first hash; generate tokens, respective ones of the tokens associated with respective ones of the users; and transmit the tokens to a server associated with the branded product.

In another aspect of the invention, there is a system including a processor set, one or more computer readable storage media, and program instructions collectively stored on the one or more computer readable storage media. The program instructions are executable to: receive a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product; receive a hash pre-image; compare the hash pre-image with the first hash; retrieve a list of users associated with the virtual IDs of the first hash; generate tokens, respective ones of the tokens associated with respective ones of the users; and transmit the tokens to a server associated with the branded product.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flow diagram showing an exemplary use of the method in accordance with aspects of the present invention.

### DETAILED DESCRIPTION

Aspects of the present invention relate generally to message authentication and, more particularly, to methods and systems for automatically authenticating messages based on interactions in the metaverse, particularly when brands send messages, e.g., via a telemarketer, to real world users of the metaverse.

As more brands participate in the metaverse, fraudulent brands and impersonators arise to deceive other users with fake products and misleading information (offers), possibly leading to purchases of fake products in the real world. Therefore, it is desirable to confirm that brands appearing in the metaverse and their information and products are authentic, particularly when brands (or telemarketers working on behalf of the brand) send messages (e.g., product information or advertisements) to real world users of the metaverse based on their interaction in the metaverse.

Aspects of the present invention provide systems and methods for authenticating brands appearing in the metaverse to ensure that the brand is authentic and not a fake. The authentication is particularly important when the brand wishes to send messages (e.g., information, offers, etc.) to users of the metaverse in the real world. Aspects of the present invention are configured to: 1) generate scrubbed tokens for virtual world avatars in order to facilitate participating brands to send promotional messages for interested avatars; 2) provide efficient and differential scrubbing capability (association between the brand with the category and authenticity with the relevant product/service being offered) based on the promotion that is selected by the user; 3) direct promotional messages in the real world based on their preference to identified avatars or their surroundings in the virtual space; 4) establish brand authenticity to reduce the probability of fraudulent activities; and 5) avoid correlation between avatars and users (individual behind the avatar) by the brand.

Implementations of the invention are necessarily rooted in computer technology. For example, the step of generating tokens is computer-based and cannot be performed in the human mind.

It should be understood that, to the extent implementations of the invention collect, store, or employ personal information provided by, or obtained from, individuals (for example, information relating to the user), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as authentication code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

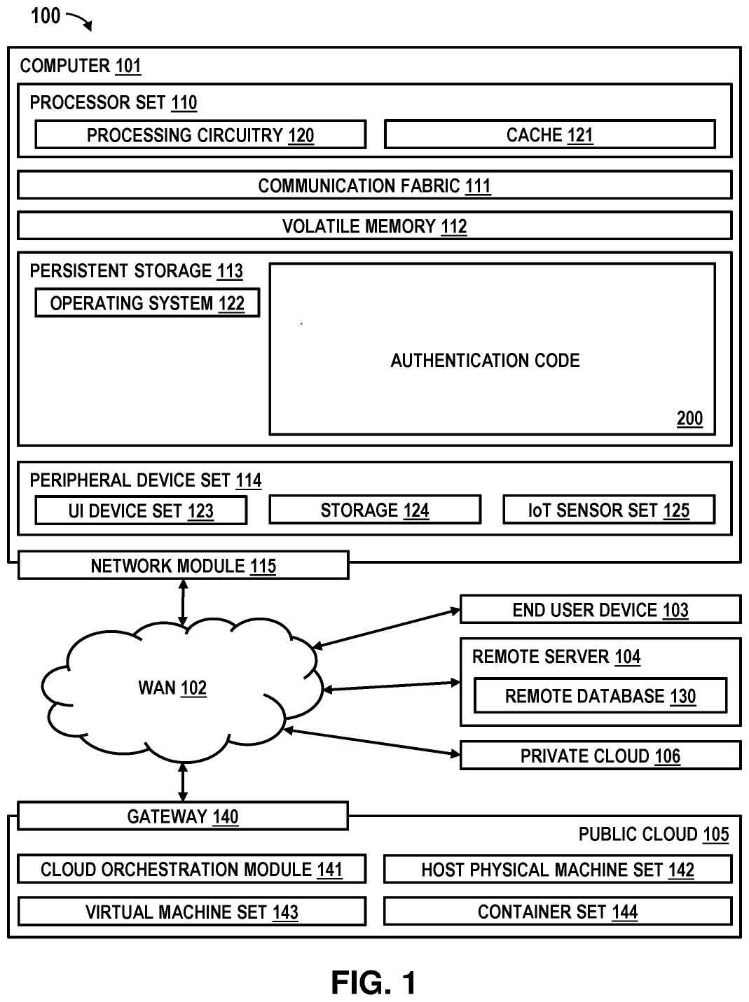

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

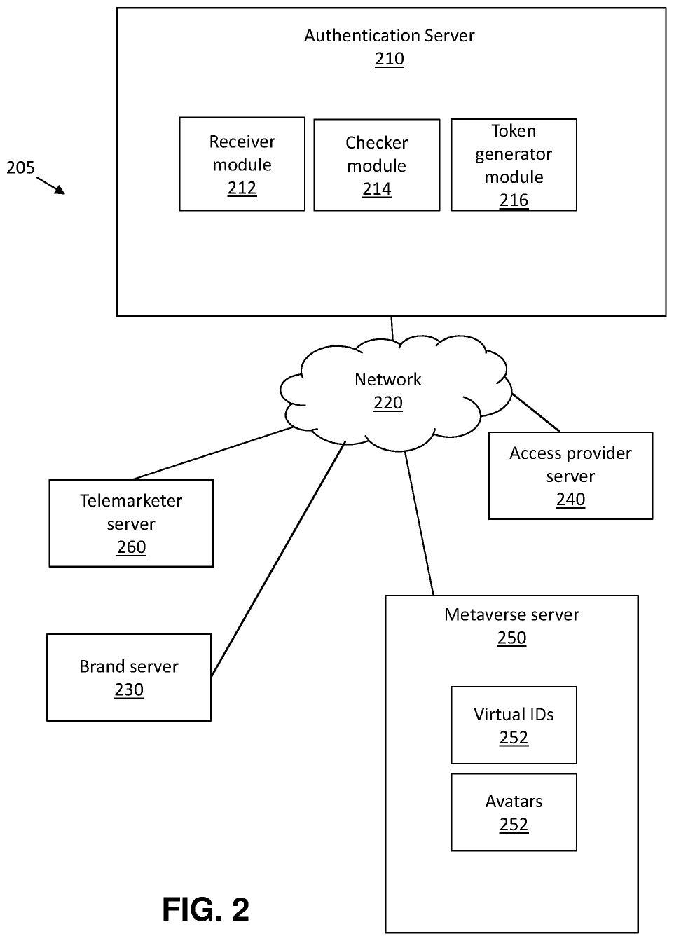

FIG. 2 shows a block diagram of an exemplary environment 205 in accordance with aspects of the invention. In embodiments, the environment 205 includes an authentication server 210, a brand server 230, an access provider server 240, a metaverse server 250, and a telemarketer server 260. The authentication server 210, the brand server 230, the access provider server 240, and the metaverse server 250 are in communication over a network 220. In an example, the authentication server 210 comprises one or more instances of the computer 101 of FIG. 1, or one or more virtual machines or one or more containers running on one or more instances of the computer 101 of FIG. 1. Each of the brand server 230, access provider server 240, metaverse server 250, and telemarketer server 260 comprises one or more virtual machines or one or more containers running on one or more instances of the remote server 104 of FIG. 1. The network 220 may comprise one or more networks such as the WAN 102 of FIG. 1.

In embodiments, the metaverse server 250 provides a platform for the metaverse. To use the metaverse, a user registers his avatar and is assigned a virtual identification (ID) associated with the avatar. The avatar is a representation of the user in the metaverse. As such, with i number of registrations (a user may register more than one avatars), the metaverse server 250 includes avatars 252 {Ai1, Ai2, . . . Ain} and virtual IDs 254 {Vi, Vi2, . . . Vin}. Each virtual ID is assigned to an avatar. The registration process may also require other real-world identification information from the user, such as cellular phone number, names, home address, e-mail address, preference for receiving product(s)/service(s) information in the real world, etc. As used herein, unless otherwise indicated, “product” and “service” are used interchangeably when referring to the branded product or service. When each brand registers and first appears in the metaverse, a space for the brand is defined in the metaverse. In embodiments, the brand is vetted by the metaverse platform to ensure that the brand is authentic (not an imposter). In the metaverse, avatars may interact with each other and visit the space for different brands to interact with (e.g., obtain information, view) the brand's product(s)/service(s), e.g., obtain information on or view the product(s)/service(s). Interaction of each avatar with a branded product is recorded with appropriate time stamp marking the time of the interaction. The metaverse server 250 maintains a list of virtual IDs that interacts with a branded product(s) and the corresponding time stamps for the interactions. A hash of the product and virtual IDs and product ((hash (product, virtual IDs)=H) is sent to the brand server 230 along with the corresponding time stamps for the interactions between the virtual IDs and product(s). That hash is referred to herein as “first hash”. The list is updated periodically as more avatars interact with the branded product. Every time the list is updated, a new first hash and time stamps are sent to the brand server 230 by the metaverse server 250. The pre-image of the first hash (hash pre-image) is also sent to the brand server 230.

In embodiments, the brand server 230 is a remote server operated by the owner of the brand. The brand server 230 obtains, from the metaverse server 250, the first hash and the hash pre-image. The brand server 230, however, does not know the real-world identity of the users with whom it interacts in the metaverse (the users behind the virtual IDs on the hash pre-image). As used herein, unless otherwise indicated, “user” refers to a real-world individual behind the avatar in the metaverse. The brand server 230 obtains the first hash (along with the corresponding time stamps) from the metaverse server 250, and submits the first hash and the time stamp to the authentication server 210. In embodiments, the first hash and the time stamp may be submitted to the authentication server 210 directly or via the access provider server 240. The brand server 230 also receives the hash pre-image from the metaverse server 250 and forwards the hash-pre-image to the telemarketer server 260 whenever the brand server 230 wishes to communicate with real-world users behind the avatars.

In embodiments, the telemarketer server 260 is a remote server operated by a telemarketer working on behalf of the brand owner to send messages (e.g., advertisements) to real-world users whose avatars have interacted with the branded product(s) in the metaverse. The telemarketer server 260 receives the pre-hash image from the brand server 230 when the brand server 230 wishes to send a message to the users. The telemarketer server 260 communicates with the access provider server 240 to send the message.

In embodiments, the access provider server 240 is a remote server operated by an access provider. The access provider may be, e.g., a cellular phone service provider from whom the brand owner may request to send messages (e.g., product advertising or information) to real world users whose avatars have interacted with the branded product/service in the metaverse (users behind the avatars). The access provider server 240 is able to access real world telephone numbers of the users from the metaverse server 250 or the access provider server 240 itself. In embodiments, the access provider server 240 may receive the first hash from the brand server 230 and forwards the first hash to the authentication server 210. When the access provider server 240 receives a request from the telemarketer server 260 to send messages to real world users whose avatars have interacted with the branded product/service in the metaverse, the access server 240 invokes the authentication code 200 on the authentication server 210 to authenticate the telemarketer message and perform scrubbing so that the brand server 240 and the telemarketer server 260 do not receive information (e.g., name, telephone number, home address. e-mail address, etc.) of the real-world users behind the avatars.

In embodiments, the authentication server 210 of FIG. 2 comprises a receiver module 212, a checker module 214, and a token generator module 216, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The authentication server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the receiver module 212 receives the first hash from the brand server 230. When the telemarketer server 260 submits a message, e.g., a text message, to the access provider server 240 to be sent to users behind the avatar, the telemarketer server 260 also submits a pre-image of the first hash and a message header to the access provider server 240. The message header is a code which identifies the brand and the access provider. The access provider server 240 forwards the pre-image to the receiver module 212.

In embodiments, the checker module 214 then checks the pre-image to make sure that it matches the first hash (hash of pre-image=H, e.g., sha256hash (x)=H). If there is no match, the message is rejected as the submission is likely fraudulent. In embodiments, the access provider server 240 and/or the metaverse server 250 are notified of the possible fraudulent activity. If there is a match, the message is authenticated as being from an authenticated brand; and checker module 214 retrieves, from the metaverse server 230, a list of real-world users for the virtual IDs. The list may also include phone numbers, e-mails, etc. for the users. In embodiments, the checker module 214 may also match the time stamps submitted by the brand server 230 with actual time stamps to further authenticate the brand. The actual time stamps for the virtual IDs may be obtained from the metaverse server 250. The checker module 214 matches the time stamp submitted by the brand server 230 with the actual time stamp (from the metaverse server 250) to further authenticate the brand.

In embodiments, the checker module 214 also determines whether each user has consented to receiving messages from the brand. The consent may be found from the metaverse server 240 or from the access provider server 240. For example, the user's telephone may include a do not disturb setting which can be ascertain from the access provider server 240. In another example, the user may consent to receiving messages from the brand when signing up to use the metaverse, which can be ascertain from the metaverse server 250. As such, the checker module 214 communicates with both the access provider server 240 and the metaverse server 250 to determine whether each user has consented to receiving messages from the brand. The checker module 214 then modifies the list of users to remove those who do not consent to receiving messages from the brand.

In embodiments, the token generator module 216 generates a token for each user who has consented to receiving messages from the brand. Each token is virtual and uniquely associated with an individual user (and thus a virtual ID). For example, each token may be a virtual ten (10) digit number which correspond to user A behind avatar A having virtual user ID A and real-world telephone number A. The token may be generated, e.g., by a random string generator or a block chain platform (such as a distributed ledger). The token generator module 216 transmits the tokens (but not the associated phone numbers or any other user information) to the telemarketer server 260. That way, the telemarketer server 260 does not know the phone number or the identity of real-world users behind the avatars (or virtual IDs). The token generator module 216 also transmits the tokens and their associated phone numbers are transmitted to the access provider server 240. That way, when the access provider server 240 receives the tokens from the telemarketer server 260, the access provider server 240 knows which number is associated with each token.

In embodiments, the telemarketer server 260 can then submit the tokens to the access provider 240 along with the message header and message body for delivery of the message to the users. From the tokens submitted by the brand server 230, the provider server 240 forwards the message to the phone numbers of users associated with the tokens. In embodiments, the service provider server 240 may further check to determine whether a do not disturb lock is present for each phone number. If a do not disturb lock is in place, the message is not sent to that phone number.

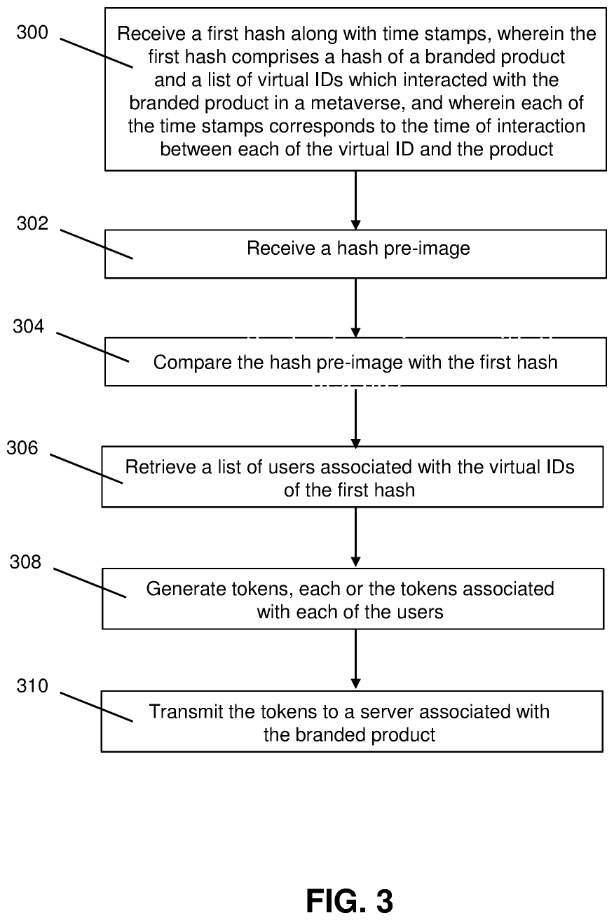

FIG. 3 shows a flowchart of an exemplary method in accordance with aspects of the present invention. Steps of the method may be carried out in the environment of FIG. 2 and are described with reference to elements depicted in FIG. 2.

At step 300, the authentication server 210 receives a first hash along with time stamps, wherein the first hash comprises a hash of a branded product and a list of virtual IDs which interacted with the branded product in a metaverse, and wherein each of the time stamps corresponds to the time of interaction between each of the virtual ID and the product. In embodiments, as described with respect to FIG. 2, the receiver module 212 performs this step.

At step 302, the authentication server 210 receives a hash pre-image. In embodiments, as described with respect to FIG. 2, the receiver module 212 performs this step.

At step 304, the authentication server 210 compares the hash pre-image with the first hash. In embodiments, as described with respect to FIG. 2, the checker module 214 performs this step.

At step 306, the authentication server 210 retrieves a list of users associated with the virtual IDs of the first hash. In embodiments, as described with respect to FIG. 2, the checker module 214 performs this step.

At step 308, the authentication server 210 generates tokens, each or the tokens associated with each of the users. In embodiments, as described with respect to FIG. 2, the token generator module 216 performs this step.

At step 310, the authentication server 210 transmits the tokens to a server associated with the branded product. In embodiments, as described with respect to FIG. 2, the token generator module 216 performs this step.

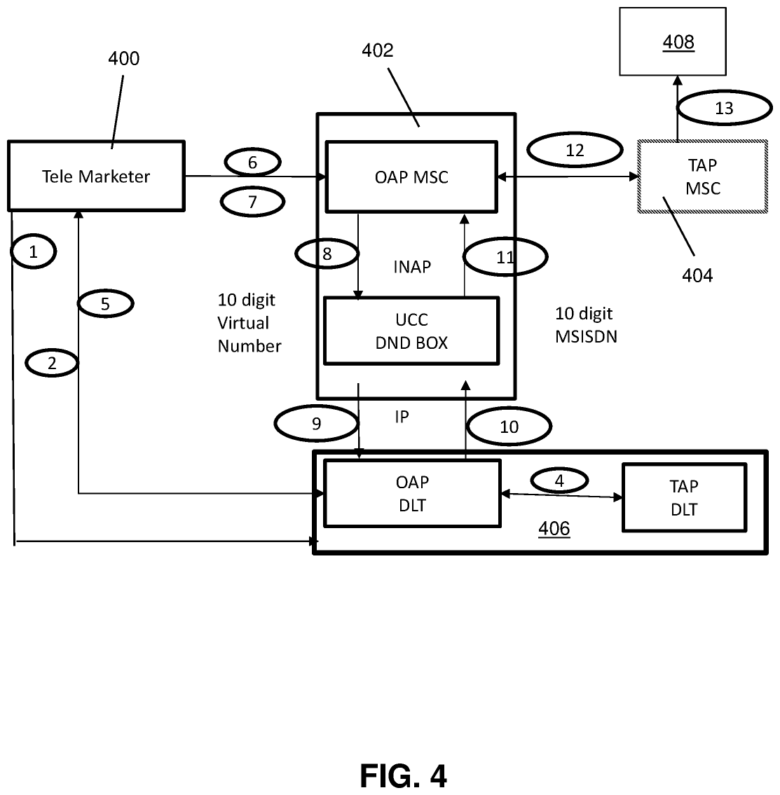

FIG. 4 is a flow diagram showing an exemplary use of the authentication server 210 in accordance with aspects of the present invention. In this case, a telemarketer 400 works with an originating access provider (OAP) 402 and a terminating access provider (TAP) 404, to deliver an unsolicited commercial communication (UCC) from a brand to the user 408. Overall, the brand owner shares with the telemarketer 400 the hash pre-image to send the UCC. The telemarketer submits the hash pre-image to the OAP 402 who maintains the consent data on a distributed ledger (DLT) 406. A scrubbing process is then invoked which uses the authentication server 210 described above to check for the correctness of the hash and return tokens for the mobile numbers corresponding to the avatars virtual IDs that have provided consent to receiving the UCC. In this example, the consent token is a virtual 10-digit number. The telemarketer 400 can submit the virtual token along with the UCC to be sent to the OAP. The OAP retrieves the user telephone numbers from the DLT 406 and sends the UCC to the TAP 404 which then delivers the UCC to the users 408.

In FIG. 4, numbers inside the ovals indicate the steps as described below. The steps need not occur in sequential order, but show the flow of information and the actions taken between the different entities in the system.

In step 1, the telemarketer registers with the DLT 406. The telemarketer may register on to the DLT 406 via a partner onboarding module provided by the OAP 402.

In step 2, the brand owner submits the first hash and time stamps to the OAP 402 as described above. That first hash is then compared to the pre-image submitted by the telemarketer for authentication. This process is as described above for the receiver module 212 and the checker module 214.

In step 4, user consent to receiving the UCC is checked within the DLT 406.

In step 5, the virtual 10-digit numbers (tokens) are sent to the telemarketer.

In step 6, the telemarketer 400 composes the UCC header and message body and submits them with the virtual 10-digit numbers.

In step 7, the scrubbing service is invoked. This scrubbing process involves the use of the authentication server 210 as noted above.

In step 8, the virtual 10-digit numbers are translated to users' telephone numbers within the OAP 402 and verifies if there is a do not disturb (DND) request associated with the telephone numbers.

In step 9, if there is no DND request, the telephone numbers are sent to the DLT 406.

In step 10, the telephone numbers are verified at the OAP 402.

In step 11, the telephone numbers which passes scrubbing is passed to the OAP mobile switching center (MSC).

In step 12, the OAP 402 initiates the UCC to the TAP 404.

In step 13, the TAP 404 sends the message to the users 408.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising
receiving, by a processor set, a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product;
receiving, by the processor set, a hash pre-image;
comparing, by the processor set, the hash pre-image with the first hash to authenticate the branded product;
retrieving, by the processor set, a list of users associated with the virtual IDs of the first hash;
generating, by the processor set, tokens, respective ones of the tokens being associated with respective ones of the users; and
transmitting, by the processor set, the tokens to a server associated with the branded product.

2. The computer-implemented method of claim 1, further comprising determining whether each of the users consented to receiving a message regarding the branded product.

3. The computer-implemented method of claim 2, wherein the generating only generates tokens for users who consented to receiving the message.

4. The computer-implemented method of claim 2, wherein the determining comprises communicating with a service provider server and a metaverse server to obtain a list of users who have not consented.

5. The computer-implemented method of claim 1, wherein the list comprises telephone numbers associated with the users.

6. The computer-implemented method of claim 1, wherein a random string generator is used for generating the tokens.

7. The computer-implemented method of claim 1, further comprises transmitting the tokens to a service provider.

8. The computer-implemented method of claim 1, wherein the receiving, generating, and transmitting occurs only if the hash pre-image and the first hash matches.

9. The computer-implemented method of claim 1, further comprising rejecting the branded product as fraudulent if the hash pre-image and the first hash do not match.

10. A computer program product comprising one or more computer readable storage media having program instructions collectively stored on the one or more computer readable storage media, the program instructions executable to:
receive a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product;
receive a hash pre-image;
compare the hash pre-image with the first hash;
retrieve a list of users associated with the virtual IDs of the first hash;
generate tokens, respective ones of the tokens associated with respective ones of the users; and
transmit the tokens to a server associated with the branded product.

11. The computer program product of claim 10, wherein the program instructions are further executable to determine whether each of the users consented to receiving a message regarding the branded product.

12. The computer program product of claim 11, wherein the generating only generates tokens for users who consented to receiving the message.

13. The computer program product of claim 11, wherein the determining comprises communicating with a service provider server and a metaverse server to obtain a list of users who have not consented.

14. The computer program product of claim 10, wherein the list comprises telephone numbers associated with the users.

15. The computer program product of claim 10, wherein a random string generator is used to generate tokens.

16. The computer program product of claim 10, wherein the program instructions are further executable to transmit the tokens to a service provider.

17. The computer program product of claim 10, wherein the receiving, generating, and transmitting occurs only if the hash pre-image and the first hash matches.

18. The computer program product of claim 10, wherein the program instructions are further executable to reject the branded product as fraudulent if the hash pre-image and the first hash do not match.

19. A system comprising a processor set, one or more computer readable storage media, and program instructions collectively stored on the one or more computer readable storage media, the program instructions executable to:
receive a first hash along with time stamps, wherein the first hash comprises a hash of a branded product and a list of virtual identifications (IDs) which interacted with the branded product in a metaverse, and wherein each of the time stamps corresponds to the time of interaction between each of the virtual ID and the product;
receive a hash pre-image;
compare the hash pre-image with the first hash;
retrieve a list of users associated with the virtual IDs of the first hash;
generate tokens, respective ones of the tokens associated with respective ones of the users; and transmit the tokens to a server associated with the branded product.

20. The system of claim 19, wherein the program instructions are further executable to determine whether each of the users consented to receiving a message regarding the branded product.
